(19) United States
(12) Patent Application Publication
(10) Pub. No.: US 2021/0318243 A1
(43) Pub. Date: Oct. 14, 2021

(54) DEVICE AND METHOD FOR DETECTING AND/OR EVALUATING ARTICLES OR PRODUCTS

(71) Applicant: Fraunhofer-Gesellschaft zur Foerderung Der Angewandten Forschung, Muenchen (DE)

(72) Inventors: Philipp WOLLMANN, Dresden (DE); Wulf GRAEHLERT, Dresden (DE); Florian GRUBER, Dresden (DE)

(73) Assignee: Fraunhofer-Gesellschaft zur Foerderung Der Angewandten Forschung, Muenchen (DE)

(21) Appl. No.: 17/252,759

(22) PCT Filed: Jun. 14, 2019
(86) PCT No.: PCT/EP2019/065742

§ 371 Date: Dec. 26, 2020

(30) Foreign Application Priority Data
Jun. 20, 2018 (DE) 10 2018 210 019.5

(51) Int. Cl. G01N 21/64; G01N 21/65; G01N 21/89; G01N 21/88

(52) U.S. Cl. CPC G01N 21/6456; G01N 21/65; G01N 2021/6471; G01N 21/8806; G01N 2021/8845; G01N 21/8903

(57) ABSTRACT

A device for detecting or evaluating articles or products, irradiated by a laser beam, for generation of Raman or fluorescence radiation on surfaces of them, and generated radiation is directed to a detector array designed for locally resolved detection of the radiation. Monochromatic electromagnetic radiation with no influence on Raman or fluorescence radiation is directed at the articles or products. Detectors detect radiation reflected or scattered by articles or products in a locally resolved manner. An optical filter or beam splitter is arranged between articles or products and detector array. Irradiation and detection are carried out during relative movement between articles or products, focal range of the laser beam, diodes emitting electromagnetic radiation and detectors of the detector array. Detectors are connected to an electronic evaluation unit designed for locally and spectrally resolved evaluation of detected intensities of Raman or fluorescence radiation and for image analysis.

### BACKGROUND OF THE INVENTION

The invention relates to a device and a method for recognizing and/or assessing articles or products. The articles or products may be different and in particular may be industrially produced articles or products. When performing an assessment, the quality may preferably be examined, and a classification, sorting or assignment may be carried out, as appropriate.

Until now, the optical examination of industrial products was performed in different ways:
a manual visual inspection by staff;
use of grayscale or color cameras with monochromatic or broadband illumination;
spectral imaging (HSI) with broadband illumination.

It is possible that errors may occur during the recognition or assessment process. It is also possible that certain properties might not be recognized. A further disadvantage is the amount of time that is usually required, this also being due to a limited achievable automatability.

The object of the invention is therefore to describe possibilities for the recognition and/or assessment of articles or products by means of which the recognizability of said articles or products may be improved and the assessment quality and reliability may be increased, this being achieved moreover in particular alongside high productivity.

### SUMMARY OF THE INVENTION

In accordance with the invention, this object is achieved by a device having the features of the claims. Advantageous embodiments and developments of the invention may be realized by features described in dependent claims.

In the device according to the invention, one or more articles or products are irradiated with a laser beam that is emitted by a laser beam source, such that Raman or fluorescence radiation is generated at surfaces or regions of the surface of articles or products.

The generated Raman or fluorescence radiation is directed towards a detector array designed for the spatially resolved detection of this radiation. In this case, detectors of the detector array may be arranged in an arrangement of rows, for example oriented perpendicularly to the direction of forward movement of a stream of articles or products, or may be arranged in an arrangement of rows and columns, by means of which it may preferably be possible to perform a detection over the width of the stream.

At least approximately monochromatic electromagnetic radiation, the central wavelength of which is selected such that there is no influence on the Raman or fluorescence radiation during the detection, is directed towards the articles or products, preferably over the width of the separated articles or products, and is emitted by a plurality of diodes emitting this electromagnetic radiation. The individual detectors of the detector array are designed for the spatially resolved detection of electromagnetic radiation reflected or scattered by the articles or products.

An optical filter or a beam splitter is arranged between the articles or products and the detector array and is designed such that electromagnetic radiation with the wavelength of the laser beam does not impinge on the detectors of the detector array. In this case, an optical filter may be a bandpass or edge filter. Electromagnetic radiation from the wavelength range of the laser radiation of the laser beam may be deflected using a beam splitter in such a way that this wavelength range of the laser radiation is unable to impinge on detectors of the detector array.

The irradiation and detection are performed during a relative movement between the articles or products, the focal range of the laser beam, diodes emitting the electromagnetic radiation, and the detectors of the detector array. Generally, the articles or products are moved and all other mentioned components may be rigidly fixed. There is merely a movement of the focal range of the laser beam over the surface or regions of the surface of articles or products when the laser beam is deflected by a pivotable or rotatable reflective element.

At least the detectors of the detector array are connected to an electronic evaluation unit. The electronic evaluation unit is designed for the spatially and spectrally resolved evaluation of intensities of the Raman or fluorescence radiation detected by detectors of the detector array and also for carrying out an image analysis to determine the shape and position recognition of individual articles or products.

The laser beam for exciting Raman or fluorescence radiation may be directed by means of a reflective element, pivotable or rotatable about at least one axis, or by means of a linear optical lens across the width in which articles or products are arranged. Pivotable reflective elements may be what are known as scanner mirrors or galvo mirrors. A rotatable reflective element may have, distributed over its circumference, a plurality of planar reflective faces, towards which a beam may be directed successively during the rotation. Said element may have the form of a polygon mirror, with a plurality of reflective planar faces arranged successively in the rotation direction over the circumferential surface of the element.

A reflective element pivotable about at least one axis or rotatable about a rotation axis should be designed or controllable such that the focal range of the laser beam moves in the event of the generation of Raman or fluorescence radiation at a frequency that is greater than the frequency at which the detection is performed.

The electronic evaluation unit should advantageously be designed to recognize spectral intensity differences of intensities of at least one wavelength detected by detectors and/or to extract parameters, in particular by means of a multivariate or chemometric data analysis, preferably by a principal component analysis, discriminant analysis, support vector method, a neural network, cluster analysis, or random forest method.

Conventional hyperspectral image systems (HSI systems) may be used for the detection. In this case, economical silicon-based detectors may be used. The samples to be sorted may be excited optically, contactlessly with the aid of a laser beam. Depending on the material, Raman scattering or fluorescence is excited. The laser wavelength should selected such that:
a) The signals of the Raman scattering/fluorescence may be detected in the optimal region of the detectors. This may be the region with the highest quantum efficiency.
b) A further region of the detector array may be used for the shape recognition; the central wavelength (CWL) of a row whose diodes may emit at least approximately monochromatic electromagnetic radiation may be selected such that there is no influence on the Raman/fluorescence signals detected by detectors.

For example, detectors that are sensitive in a wavelength range between 400 nm-1000 nm and laser radiation with a wavelength of 532 nm may be used. Raman/fluorescence may be detected up to approximately 700 nm and diodes with a CWL of 850 nm may be used for irradiation and then for an image analysis.

The spectrally resolved data detected at individual detectors may be processed separately.
a) Evaluation of the (Raman/fluorescence) spectra;
b) Separation of the data from the diode excitation for shape and location/position recognition or for image analysis

The parameters necessary for the particular task may be extracted from the spectra detected in spatially resolved fashion by the detectors. These parameters may be obtained both from spectral intensity differences (at one or more wavelengths) and as a unique criterion of a multivariate/chemometric data analysis (for example principal component analysis, discriminant analysis, support vector method, neural network [deep learning methods], cluster analysis, or random forest methods, etc.).

The determined shape, color, layer, surface, material and position/location parameters or data obtained from the image analysis may in turn be used jointly with the findings obtained from the spectral evaluation for a further sample classification/sample assessment for samples that are formed with a plurality of articles or products.
The use of the hyperspectral technique or imaging spectroscopy enables the planar (laterally resolved) characterization on the basis of
   the evaluation of spectra (transmission or(/and) reflection) that were measured (here in a line) simultaneously at different locations of a sample formed with articles or products
   a relative movement sample/detector array
Preconditions
   the laser beam (coherent, monochromatic point source) may be guided by means of a scanner mirror (galvano scanner) over the width of the stream formed by articles or products or on the surface of individual articles or products, which should be performed at a much higher speed than the recording frequency
      alternatively, an optical line lens may also be used, so that the intensity introduced selectively per location point, per unit of time, decreases
   the laser beam may be introduced obliquely or perpendicularly via a dichroic beam splitter
   an optical edge or notch filter may be arranged in front of the HSI system, by means of which filter the excitation wavelength for the detectors may be blocked, since otherwise this may result in an overexposure and signal superimposition
   diodes, for example a row of diodes, may be introduced on one side or two sides of an observation line; the angle is variable (shadowing must be ensured where necessary)

Due to the intrinsic combination of machine-based imaging (rows of diodes) and imaging spectroscopy (HSI system) for the assessment, a complex determination of assessment features may be achieved, in particular with inclusion of shape/uniformity of the different articles or products.

The object of the invention is therefore, on the basis of laser excitation, to simultaneously detect Raman and/or fluorescence signals and also data for shape recognition/image detection in an unused spectral region of detectors. Previously, it would have been necessary to perform this in two separate optical test systems (spectroscopy system+machine vision system). This enables a completely new kind of optical inspection of surfaces and components (generally: industrial articles).

The following advantageous effects may be achieved with the invention:
a.
   i. there is no need for a duplicate interpretation of optical inspection systems (no duplicate software, duplicate process integration, etc.);
   ii. intrinsic combination of machine-based imaging and imaging spectroscopy;
   iii. complex quality assessments and determination of complex quality features, in particular if the shape/location/uniformity in the area must be included;
   iv. low spatial requirement for process integrations;
   v. surface is examined contactlessly and free from contamination;
   vi. rapid, complete and automatable quality control; and
   vii. in-line monitoring directly at or in the production.

The invention may be used for the quality and process control of industrial articles, such as:
glasses, films, wood, ceramic and metallic surfaces, coatings and paints;
structured surfaces or structured components/products;
purity/cleanliness inspection;
complex technical components;
   in automotive engineering, aircraft construction, apparatus and equipment engineering, semiconductor industry, coaters, manufacturers of optical glasses.

The invention will be explained in greater detail hereinafter.

### DESCRIPTION OF THE DRAWING

In the drawing:

FIG. 1 shows an example of a device according to the invention in a schematic depiction.

### DESCRIPTION OF THE INVENTION

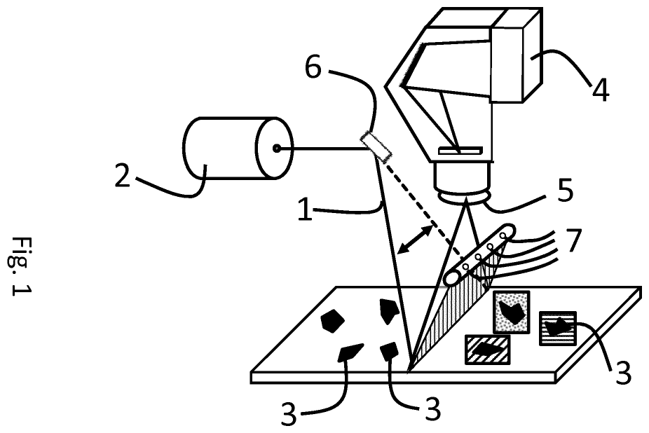

In FIG. 1 merely the optical part of the device is shown and the depiction of the electronic evaluation unit has been omitted.

A laser beam 1 with a wavelength of 532 nm is directed by means of a laser radiation source 2 over a stream comprising products 3 via an element 6 which is pivotable about an axis and which reflects the laser beam 1. The focus of the laser beam 1 is directed here over the entire width of the stream, which is formed by the products 3 and moves in one direction. The focus moves here perpendicularly to the direction of movement of the stream. As a result of this irradiation, Raman scattering is generated and/or fluorescence radiation is excited.

At the same time, the stream is irradiated linearly by electromagnetic radiation, which is emitted by an arrangement of diodes 7 in a row. This electromagnetic radiation has a central wavelength of 850 nm and a scattering around this wavelength of ±10%. This irradiation is preferably performed in the region of the surfaces of the products 3 in which Raman scattering or fluorescence radiation is no longer detected.

Above the irradiation region, there is arranged a detector array 4, which is formed with a plurality of detectors arranged in rows or in rows and columns. The detectors are designed such that they enable a spatially and spectrally resolved detection of intensities.

A spectral, spatially resolved analysis and a spatially resolved image analysis are thus possible.

The measurement signals of the individual detectors are supplied to an electronic evaluation unit (not shown), by means of which an assessment of products 3, for example made of specific materials or having specific shapes or colors/color combinations, may be performed.

In order to enable a practically undisturbed detection of the measurement signals, an optical filter 5 is arranged between the region irradiated by the laser beam 1 and the detector array 4, by means of which filter it is possible to prevent reflected and scattered laser radiation from impinging on the detectors of the detector array 4 and possibly negatively influencing the actual measurement signals. The optical filter 5 in this example is an edge filter which is practically fully transparent only for electromagnetic radiation with wavelengths greater than 532 nm.

The evaluation may be performed by means of a PC. The data detected by the detector must be transmitted via a sufficiently fast data connection. The software must be capable of evaluating the data with the speed of the detection. The approach for evaluation may be fixedly defined as a “formula” or will have been freely defined beforehand. Ideally, only the results of the evaluation are stored; the original data are discarded. Besides the results of the recognition, further data such as location information and timestamp may also be detected and forwarded.

1. A device for detecting and/or evaluating articles or products, in which articles or products are irradiated by a laser beam emitted by a laser beam source so that Raman or fluorescence radiation is generated at surfaces of the articles or products, and
the generated Raman or fluorescence radiation is directed towards a detector array designed for spatially resolved detection of this radiation,
at least approximately monochromatic electromagnetic radiation, a central wavelength of which is selected such that there is no influence on the Raman or fluorescence radiation during detection, is directed towards the articles or products, over the surface or regions of the surface of the articles or products, and is emitted by a plurality of diodes emitting this electromagnetic radiation, and
detectors of the detector array are designed for the spatially resolved detection of electromagnetic radiation reflected or scattered by the articles or products,
an optical filter or a beam splitter is arranged between the articles or products and the detector array and is designed such that electromagnetic radiation with the wavelength of the laser beam does not impinge on the detectors of the detector array;
wherein the irradiation and detection are performed during a relative movement between the articles or products, a focal range of the laser beam, diodes emitting the electromagnetic radiation, and the detectors of the detector array, and
at least the detectors of the detector array are connected to an electronic evaluation unit, and
the electronic evaluation unit is designed for spatially and spectrally resolved evaluation of intensities of the Raman or fluorescence radiation detected by the detectors of the detector array and for carrying out an image analysis for determining shape, color or surface recognition of individual articles or products.

2. The device according to claim 1, wherein the laser beam is directed with a reflective element, pivotable or rotatable about at least one axis, or by means of a linear optical lens across the width in which the articles or products are arranged.

3. The device according to claim 1, wherein the electronic evaluation unit is designed to recognize spectral intensity differences of intensities of at least one wavelength detected by detectors or
is designed to extract parameters by means of a multivariate data analysis, by a principal component analysis, discriminant analysis, support vector method, a neural network, a cluster analysis, or random forest method.

4. The device according to claim 1, wherein a reflective element that is pivotable about at least one axis or that is rotatable about a rotation axis is designed or controllable such that the focus of the beam moves in the event of the generation of Raman or fluorescence radiation at a frequency that is greater than the frequency at which detection is performed.

5. A method for detecting or evaluating articles or products irradiated by a laser beam emitted by a laser beam source such that a generation of Raman or fluorescence radiation is achieved at surfaces or regions of a respective surface of the articles or products,
directing the generated Raman or fluorescence radiation towards a detector array designed for the spatially and spectrally resolved detection of this radiation, and emitting
at least approximately monochromatic electromagnetic radiation by a plurality of diodes directed towards the articles or products, a central wavelength of said radiation being selected such that there is no influence on the Raman or fluorescence radiation during detection, and arranging
an optical filter or a beam splitter between the articles or products and the detector array to prevent electromagnetic radiation with the wavelength of the laser beam from impinging on detectors of the detector array; wherein irradiation and detection are performed during a relative movement between the articles or products, a focus range of the laser beam, the diodes emitting electromagnetic radiation, and detectors of the detector array, and connecting
at least the detectors of the detector array which are designed for spatially and spectrally resolved detection of the articles or products, the Raman or fluorescence radiation and reflected and scattered electromagnetic radiation to an electronic evaluation unit, and
the electronic evaluation unit, is designed for spatially and spectrally resolved evaluation of intensities detected by detectors of the detector array, to evaluate the Raman or fluorescence radiation detected in a spatially resolved manner and also to perform an image analysis for determining shape, color or position recognition of individual articles or products.
